(19) United States
(12) Patent Application Publication
(10) Pub. No.: US 2005/0284278 A1
(43) Pub. Date: Dec. 29, 2005

(54) Sheet cutter

(75) Inventors: Fumio Shimizu, Tokyo (JP); Tomoyoshi Nakamura, Tokyo (JP); Muneyuki Ishihara, Tokyo (JP)

Correspondence Address: OLIFF & BERRIDGE, PLC, P.O. BOX 19928, ALEXANDRIA, VA, 22320, US

(73) Assignee: Carl Manufacturing Co., Ltd., Tokyo (JP)

(21) Appl. No.: 11/045,273

(22) Filed: Jan. 31, 2005

(30) Foreign Application Priority Data
Jun. 28, 2004 (JP) 2004-189964

(51) Int. Cl. B26D 1/04

(52) U.S. Cl. 83/614; 83/455

(57) ABSTRACT

Sheet cutter minimizing friction occurred between a slider and a guide rail while transferring the slider along the guide rail in a high linearity. Each of the slider and the guide rail has either a convex or a concave portion up and down to fit each other. In cutting processes only the convex and concave portions are made abutted each other contributing to minimization of the friction and smooth transferability of the slider in a high linearity.

BACKGROUND OF THE INVENTION

1. Field of the Invention

This invention relates to cutters for sheet material mainly papers, and more particularly, to a sheet cutter cutting the sheet material by positioning thereof by means of a paper-holding ruler.

2. Description of the Related Art

Japanese Patent Application Laid-Open No 11-33978 (hereinafter D1) discloses a sheet cutter in which a slider is movably installed to a guide rail T-shaped in section and provided on a base in such a manner that both a guide groove and a guide surface formed on a guide member of the slider are made fit to the guide rail. Japanese Patent Application Laid-Open No. 6-262586 (hereinafter D2) further relates to a sheet cutter for paper and discloses that a fitting groove for a cutter sheet is formed parallel with a rail provided on a base, and a cutter sheet presser is removably provided at the end of the fitting groove contributing to an easy exchange of the cutter sheet. Japanese Patent Application Laid-open No. 11-309695 (hereinafter D3) then relates to a lock mechanism in a paper-holding ruler and discloses that the paper-holding ruler is movably provided on a guide rail (either concave or convex form) formed on an installation table orthogonal to a cutter rail. A lock member such as a pressure plate is pressed onto the guide rail with a lever provided with the paper-holding ruler thereby locking the paper-holding ruler in a position where a user selects. Lastly, Japanese Paten Application Laid-open No. 5-337879 (hereinafter D4) relates to a sheet cutter for paper and discloses that a guiding foot integrally and orthogonally provided with a paper-positioning member is movably fit to a groove on a paper-seating table orthogonal to a rail. A lock member is pressed onto the interior wall of the groove by operating a lever provided with the paper-positioning member thereby locking the paper-positioning member in optional positions.

In D1, both the guide groove and guide surface formed on the guide member of the slider are made fit to the T-sectional guide rail so that the slider and the guide rail are abutted nearly in a whole surface making the slider guided in a high linearity. Because its contact surface rate between the slider and the guide rail is high in D1 as discussed above, early abrasion therebetween may occur. In D2, the cutter sheet presser is removably provided at the end of the fitting groove so that it helps relatively easy replacement of the cutter sheet. There however needs further operational improvement regarding how to install the cutter sheet into the fitting groove. In D3, the paper-holding ruler is movably provided on the guide rail formed on the installation table, and the paper-holding ruler is made locked with the lever. In this structure, it is not however applicable to lock the paper-holding ruler where the ruler is placed out of the installation table. In D4, the guiding foot integrally and orthogonally provided with the paper-positioning member is movably fit to the groove formed on the paper-seating table. Since the paper-positioning member is made locked with the lever provided therewith, as same as the D3, it is not applicable where placed out of the paper-seating table.

### SUMMARY OF THE INVENTION

The present invention has been made in light of the disadvantages described above, and it is a first object of the present invention to provide a sheet cutter with a slider installed to a guide rail minimizing abrasion resistance between the slider and the guide rail and enabling to guide the slider in a high linearity on the guide rail. It is further a second object of the present invention to provide the sheet cutter in which a cutter mat can be easily installed to or removed from a fitting groove on a base. It is still further a third object of the present invention to provide the sheet cutter in which a paper-holding ruler can be locked on the base even if it is placed out of the base. Hereinafter described some aspects of the present invention to achieve the above objects.

In a first aspect, a sheet cutter comprises: a base; a guide rail provided on the base; and a slider provided with a cutter and movably installed on the guide rail, in which each of the slider and the guide rail has either a convex or a concave portion up and down so as to fit each other. Thus constructed, only the convex and concave portions are made abutted each other in cutting processes so as to minimize friction occurred between the slider and the guide rail. The slider can be also moved smoothly along the guide rail in a high linearity.

In a second aspect according to the first aspect, two contacts are additionally provided from side to side between the slider and the guide rail, and these contacts are made detached from each other in cutting processes. Because the slider and the guide rail come into contact with not only at the convex and the concave portions provided up and down but also at the two additional contacts provided from side to side, the slider stays with the guide rail even if the sheet cutter is leant in its position. In cutting processes, however, only the convex and concave portions are made contact each other whereby the slider and the guide rail have less friction therebetween.

In a third aspect, a sheet cutter comprises: a base; a guide rail provided on the base; a slider provided with a cutter and movably installed on the guide rail; and a cutter mat placed on a top surface of the base and installed in a fitting groove formed along the guide rail. A guide portion is provided near the fitting groove so as to guide the cutter mat toward the fitting groove. Thus constructed, when exchanging the cutter mat, a user is only required to place the cutter mat at the guide portion. Once placed at the guide portion, the cutter mat is guided by its own weight into the fitting groove thus simplifying its exchange.

In a forth aspect according to the third aspect, a rotary end-holder is provided at at least one end of the fitting groove so as to hold the cutter mat in the fitting groove. Even in case the sheet cutter is leant, the cutter mat is still held in the fitting groove by means of the rotary end-holder.

In a fifth aspect according to the third aspect, an end fastener is also provided at one end of the fitting groove fastening one end of the cutter mat while the rotary end-holder is concurrently provided at the other end of the fitting groove retaining the other end of the cutter mat. The cutter mat can be yet surely retained in the fitting groove, and the exchange of the cutter mat is again simplified.

In a sixth aspect, a sheet cutter comprises: a base; a guide rail provided on the base; a slider provided with a cutter and movably installed on the guide rail; and a paper-holding ruler provided on a top surface of the base and installed in guide grooves orthogonally provided to the guide rail. The paper-holding ruler has foot portions orthogonally provided thereto thus making thereof movable along the guide grooves. A positioning means is further provided between the foot portions (and the guide grooves) enabling the paper-holding ruler placed in a given position. Thus constructed, even in case the paper-holding ruler is applied out of the top surface of the base, the foot portions are surely made fixed to the guide grooves by means of the positioning means.

In a seventh aspect according to the sixth aspect, the positioning means comprises: concavities formed on either the foot portions or the base; a protrusion that can be engaged with or removed from the concavities; and a protrusion operating member keeping the protrusion engaged. Thus constructed, it makes easier for the protrusion to be engaged with or removed from the concavities by simply operating the protrusion operation member.

In an eighth aspect according to the sixth and seventh aspects, the guide grooves concave in section are formed in that the bottom closing width thereof are made wider than the top opening width thereof so that the foot portions are held in the guide grooves. Irrespective of whether the sheet cutter is used or unused, the paper-holding ruler can surely stay with the guide grooves.

In a ninth aspect according to the sixth aspect, the positioning means comprises: concavities provided on either the foot portions or the top surface of the base; and a protrusion integrally formed with a plate spring and energized toward the concavities. Because the plate spring has the protrusion, the positioning means needs to have fewer components thereby simplifying the structure thereof.

In a tenth aspect according to the sixth aspect, the positioning means comprises: concavities provided on either the foot portions or a top surface of the base; and a protrusion integrally formed on either the foot portions or the top surface of the base and energized toward the concavities. Since the concavities and the protrusion are both integrally formed on either the foot portions or the base, it succeeds to reduce the number of components that the positioning means requires. The positioning means can be accordingly constructed by simply installing the foot portions into the base.

In an eleventh aspect according to the sixth aspect, the positioning means comprises: concavities provided on the foot portions; and a protrusion provided on the base and movable toward the concavities through a linkage with an operation member. Comparing with the positioning means having the energizing members such as the plate spring, the foot portions can fix further stably to the base.

In a twelfth aspect according to the sixth aspect, the positioning means comprises: concavities formed on a top surface of the base; and a protrusion energized toward the concavities by means of an energizing means. Since the positioning means is installed into the foot portions, the structure thereof is further simplified.

In a thirteenth aspect according to any one of the above aspects, the sheet cutter may have a handle so as to improve portability.

### BRIEF DESCRIPTION OF THE DRAWINGS

FIG. 1 is a perspective view of a sheet cutter according to the present invention in which a paper-holding ruler is fixed in a given position, and a cutter mat is about to install into a fitting groove;

FIG. 2 is a top plan view of the sheet cutter according to the present invention in which the paper-holding ruler is fixed out of an installation table of a base;

FIG. 3 is a back view of the sheet cutter according to the present invention;

FIG. 4 is a cross sectional view taken along line X-X of FIG. 2 where the paper-holding ruler is fixed on the installation table;

FIG. 5A is an enlarged view of a circular region D in FIG. 4, and FIG. 5B is a schematic diagram showing a slide portion between a slider and a guide rail;

FIG. 6 is a schematic diagram showing another embodiment of the slide portion between the slider and the guide rail;

FIG. 7A is an enlarged view of a circular region A in FIG. 1, and FIG. 7B is an enlarged schematic diagram showing the cutter mat, the fitting groove and a guide portion;

FIG. 8 is an enlarged view of a circular region B in FIG. 2;

FIGS. 9A, 9B and 9C are an enlarged view of a circular region C in FIG. 3, an exploded view of a positioning member in a first embodiment and a side view of a protrusion member with a protrusion respectively;

FIGS. 10A and 10B are structural views of the positioning member in a second embodiment showing engaging and non-engaging states respectively, and FIG. 10C is a cross sectional view in FIG. 10A;

FIGS. 11A and 11B are structural views of the positioning member in a third embodiment showing engaging and non-engaging states respectively;

FIGS. 12A and 12B are structural views of the positioning member in a forth embodiment showing engaging and non-engaging states respectively;

FIGS. 13A and 13B are structural views of the positioning member in a fifth embodiment showing engaging and non-engaging states respectively;

FIGS. 14A and 14B are structural views of the positioning member in a sixth embodiment showing non-fixed and fixed states respectively;

FIGS. 15A, 15B and 15C are structural views of the positioning member in a seventh embodiment. FIG. 15A shows a fixed state, FIG. 15B is a cross sectional view taken along line Y-Y of FIG. 15A, and FIG. 15C is a cross sectional view showing a non-fixed state;

FIG. 16A and 16B are structural views of the positioning member in an eighth embodiment showing engaging and non-engaging states respectively; and

FIG. 17A and 17B are structural views of the positioning member in a ninth embodiment showing engaging and non-engaging states respectively.

### DETAILED DESCRIPTION OF THE PREFERRED EMBODIMENTS

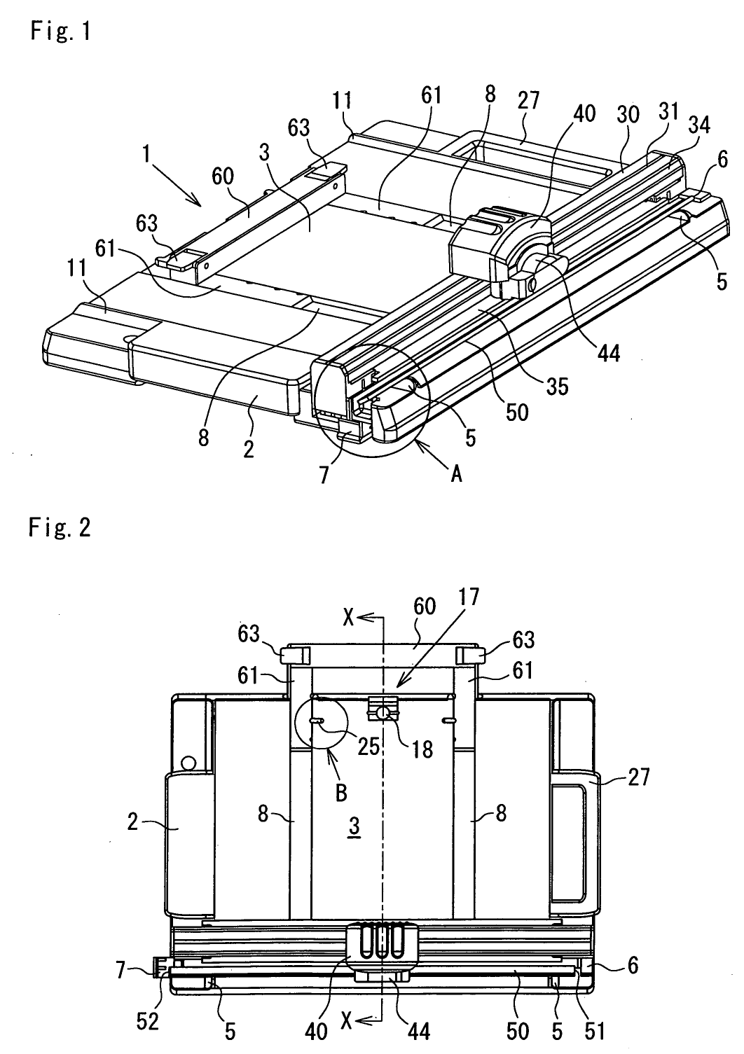

Preferred embodiments of the present invention will hereinafter be described with reference to the drawings. A sheet cutter 1 basically comprises a base 2, a guide rail 30, a slider 40, a cutter mat 50 and a paper-holding ruler 60. First, the base 2, as shown in FIGS. 1 and 2, forms in approximately square and is made of proper materials such as synthetic resin, and the top surface thereof has an installation table 3 on which sheet material such as paper is placed. The guide rail 30 is removably provided at and along either long side of the base 2 as shown in FIG. 1 while a fitting groove 4 (see FIG. 7) fitting the cutter mat 50 is provided along the guide rail 30. On the installation table 3 of the base 2, a pair of guide grooves 8, 8 is formed orthogonal to the guide rail 30. In the guide grooves 8, 8, a pair of foot portions 61, 61, which is integrally formed with the paper-holding ruler 60, is provided sidably along the guide grooves 8, 8. It may be further provided with a handle 27 at either short side of the base 2.

The present invention is not limited thereto above, but the handle 27 may be provided at both short sides of the base 2, or indication portions such as for ads may be instead provided at at least one of the short sides of the base 2. Or, a dispenser or like may be provided in lieu of the indication portions for storing replaceable cutters.

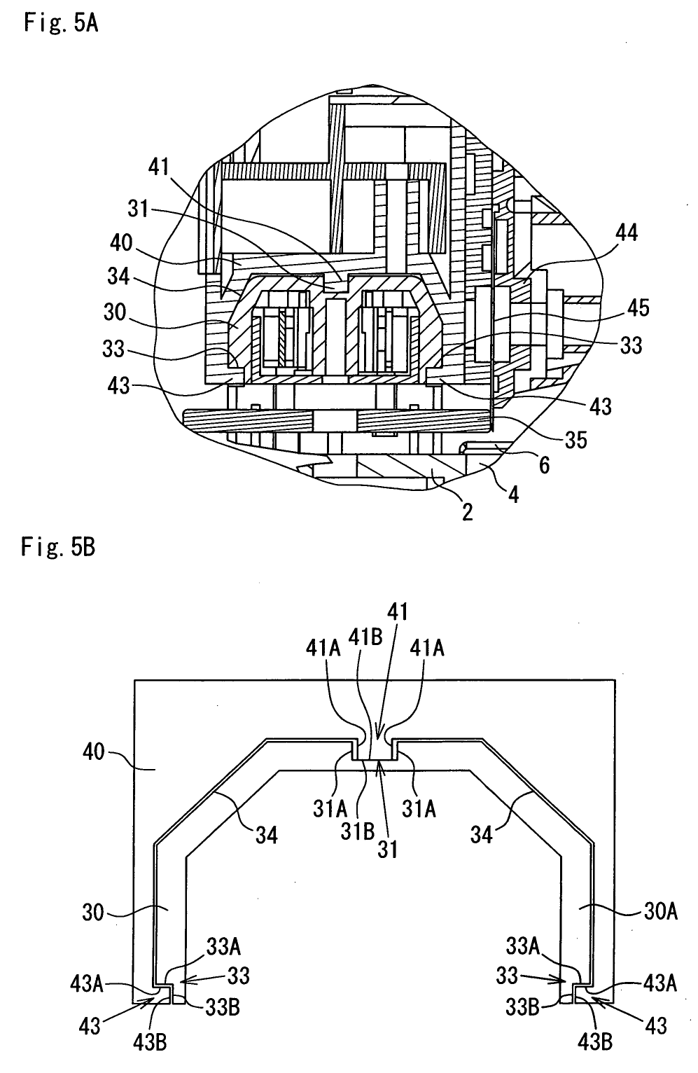

Next, details of the guide rail and the slider are hereinbelow explained. As shown in FIGS. 1 and 5, the guide rail 30 has longitudinally-continued chamfers 34 on both upper sides and is removably provided along either long side of the base 2 with an elastic member such as a coil spring (not shown). The top face of the guide rail 30 has a longitudinally-continued concave groove 31, and both bottom ends of the guide rail 30 have longitudinally-continued and undercut engaged portions 33, 33 including top portions 33A, 33A and side portions 33B, 33B. The engaged portions may have another configurations such as concave grooves.

The slider 40 has an interior surface analogous to but slightly larger than the exterior surface of the guide rail 30. The slider 40 accordingly slides on the guide rail 30 with a certain clearance in a high linearity. The inner surface of the slider 40 has a convex slide protrusion 41 corresponding to the place where the concave groove 31 is formed. And, both bottom inner sides of the slider 40 have engaging projections 43, 43 comprising top engaging projections 43A, 43A and side engaging projections 43B, 43B so as to fit to the engaged portions 33, 33 of the guide rail 30. In case the engaged portions 33, 33 are made by concave grooves, the engaging projections 43, 43 may be protrusions corresponding to the concave grooves.

When the slider 40 is placed on the guide rail 30, the slide protrusion 41 comes into contact with the concave groove 31. However, as said above, because the interior surface of the slider 40 is analogous to but slightly larger than the exterior surface of the guide rail 30, a certain clearance is formed between side concave grooves 31A, 31A of the concave groove 31 and side slide protrusions 41A, 41A of the convex slide protrusion 41. That is, there does not have any surface contact between the side concave grooves 31A, 31A and the side slide protrusions 41A, 41A except between a bottom concave groove 31B and a bottom slide protrusion 41B. This makes the slider 40 moved in a high linearity. In this embodiment, the engaging projections 43, 43 and the engaged portions 33, 33 are also made non-contact from each other by having a certain clearances therebetween. That is, clearances are respectively given between the top engaging projections 43A, 43A and the top engaged portions 33A, 33A and further between the side engaging projections 43B, 43B and the side engaged portions 33B, 33B.

When sliding the slider 40 along the guide rail 30, the side slide protrusions 41A, 41A and the side concave grooves 31A, 31A may happen to have partial contacts with each other, but even in the case the engaging projections 43, 43 and the engaged portions 33, 33 still keep non-contact from each other. Since the slide protrusion 41 is thus guided along the concave groove 31 in a high linearity, it makes possible to minimize abrasion occurred between the slider and the guide rail. By making the length of both the side slide protrusions 41A, 41A and the side concave grooves 31A, 31A longer, it is further possible to improve a rate of the linearity.

In case the sheet cutter is kept or carried with the handle 27 in inclined conditions, either the top engaging projections 43A, 43A or the side engaging projections 43B, 43B, or both may respectively abut against the top engaged portions 33A, 33A or the side engaged portions 33B, 33B, or both. The slider 40 can be thus prevented from slipping off from the guide rail 30.

As shown in FIGS. 4 and 5, the guide rail 30 further has a press member 35 along therewith pressing the sheet material in cutting processes, and there is also provided a certain clearance between the press member 35 and the installation table 3 for the sheet material interposed thereinto. In a non-working condition, the guide rail 30 is made energized upward to form the clearance. In a working condition, on the other hand, the slider 40 provided with a cutter 45 (such as a rotary cutter blade) in a cutter holder 44 is first moved aside to one end of the guide rail 30 for interposing the sheet material into the clearance. The slider 40 is then pressed downward to correspondingly press the guide rail 30. While having the sheet material been pressed with the press member 35, the slider 40 with the cutter 45 slides along the guide rail so as to cut the sheet material into optional dimensions.

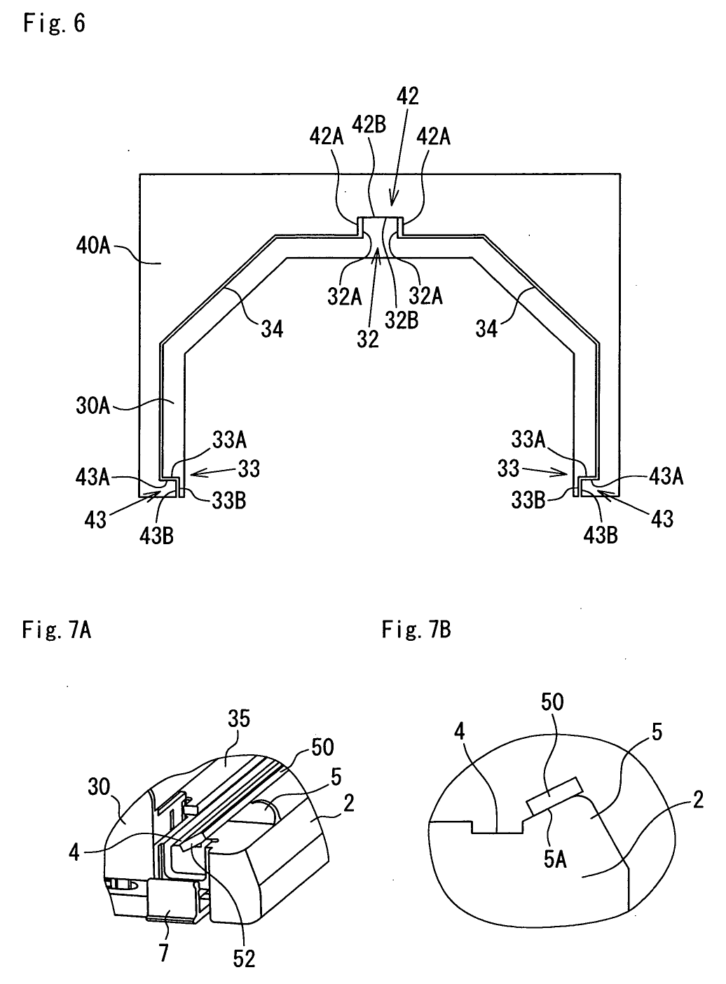

In another embodiment, as shown in FIG. 6, the top face of a guide rail 30A may have a convex protrusion 32 while the interior of a slider 40A may have a concave slide portion 42 corresponding to the place where the convex protrusion 32 is provided. The convex protrusion 32 is thus fitted to the concave slide portion 42. When the convex protrusion 32 is fitted to the concave slide portion 42, a top convex protrusion 32B and a bottom concave slide portion 42B are made contact; however, side convex protrusions 32A, 32A and side concave slide portions 42A, 42A facing each other remain non-contact. Between the side convex protrusions 32A, 32A and the side concave slide portions 42A, 42A, a certain clearance is formed so that the slider 40A can be slided on the guide rail 30A in a high linearity. And also, the engaging projections 43, 43 interiorly formed at both bottom ends of the slider 40A and the engaged portions 33, 33 formed at both bottom portions of the guide rail 30A are made non-contact due to a given clearance. This means that between the top engaging projections 43A, 43A and the top engaged portions 33A, 33A, and also between the side engaging projections 43B, 43B and the side engaged portions 33B, 33B, the given clearance is provided respectively.

A cutter mat is next explained. As shown in FIGS. 1 and 2, at one end of the fitting groove 4, an end fastener 6 is integrally provided with the base 2 so as to fasten one end portion 51 of the cutter mat 50. At the other end of the fitting groove 4, a rotary end-holder 7 is pivotally provided to the base 2 (vertically rotatable) so as to retain other end portion 52 of the cutter mat 50. Here, the cutter mat 50 may be any configurations as long as fitted to the fitting groove 4.

The end fastener 6 has an approximately inverted L-shape in section. The interior side face thereof abuts on the one end portion 51 of the cutter mat 50 controlling the position in which the cutter mat 50 is installed. On the other hand, the interior upper face thereof presses the one end portion 51 by covering one end of the fitting groove 4, so that the one end portion 51 is retained in the fitting groove 4.

The rotary end-holder 7 as the end fastener 6 has approximately inverted L-shape in section. The fitting groove 4 of one end side can be opened as shown in FIG. 7A (in a non-retaining state), so that the cutter mat 50 can be installed thereinto. After the cutter mat 50 is guided with a guide portion 5 toward the fitting groove 4, the rotary end-holder 7 now in the non-retaining position (FIG. 7A) is rotated upward having the inner face thereof abutted against the other end portion 52 of the cutter mat 50. The rotary end-holder 7 is rotated until reaching to a stopped position where the other end portion 52 is further pressed. Through the above, the cutter mat 50 is securely fixed to the fitting groove 4.

When the cutter mat 50 is retained in the fitting groove 4, the end portions 51, 52 of the cutter mat 50 are both constrained with the end fastener 6 as well as the rotary end-holder 7, both from upper and bilateral sides. Regardless of whether the sheet cutter 1 is kept aslant or carried with the handle 27, the cutter mat 50 can firmly stay with the fitting groove 4. When removing the cutter mat 50 from the fitting groove 4, the rotary end-holder 7 is rotated downward from its retaining position so as to free the one end of the fitting groove 4. Since the other end portion 52 of the cutter mat 50 has been uncovered, a user can remove the cutter mat 50 simply by hand.

Next, a guide portion will be explained. As shown in FIGS. 1, 2, 4 and 7, a pair of the guide portions 5, 5, which guides the cutter mat 50 to the fitting groove 4, is provided integrally with the base 2. The guide portions 5, 5 are placed at both proximal ends of the fitting groove 4, but the interval therebetween is made shorter than the length of the cutter mat 50. The guide portions 5, 5 include inclined portions 5A, 5A made inclined to the fitting groove 4. See FIG. 7B. The inclined angle thereof can be optional, but it may be determined in consideration of that the cutter mat 50 is slided by its own weight into the fitting groove 4 when placed on the inclined portions 5A, 5A.

The configuration of the guide portions is not limited to the aforementioned. It may however have three or more guide portions, or the inclined portions may be any optional value as long as the cutter mat is smoothly guided by hand or any other tools into the fitting groove.

A paper-holding ruler and a guide groove are explained hereinbelow referring to FIGS. 1 and 2. A pair of positioning steps 11, 11 positioning the sheet material is provided at both short sides of the base 2 and orthogonal to the guide rail 30. On the installation table 3 of the base 2 further has a pair of the guide grooves 8, 8, orthogonal to the guide rail 30, in which the foot portions 61, 61 of the paper-holding ruler 60 are sidably guided. These guide grooves 8, 8 have a concave form approximately trapezoid in section, and the foot portions 61, 61 have a convex form in section to be fitted and held at the guide grooves 8, 8. The sectional configuration of the guide grooves 8, 8 may be any inverted T-shapes as long as it has a closing bottom wider than an opening top.

The section of the foot portions 61, 61 of the paper-holding ruler 60 is correspondingly formed to the one of the guide grooves 8, 8 having the inverted T-shape. Even though the sheet cutter 1 is placed slantwise, the foot portions 61, 61 well fixed to the guide grooves 8, 8 are not accordingly pull out from the guide grooves. Although described later, by introducing projections 25, 25 into concavities 62, 62 on the foot portions 61, 61, the foot portions 61, 61 are more stably fixed to the guide grooves 8, 8.

The paper-holding ruler 60 with a pair of the foot portions 61, 61 integrally and orthogonally provided therewith has a side positioning the sheet material while concurrently retaining levers 63, 63 at both top end sides. When the paper-holding ruler 60 is placed on the installation table 3, the levers 63, 63 may function with engaging members (not shown) so as to engage with the guide grooves 8, 8. The paper-holding ruler 60 is thus positioned and fixed at a given place.

Next, a positioning means 12 of a first embodiment is hereinafter explained referring to FIGS. 2, 3 and 8. The installation table 3 of the base 2 has hollows 9, which are orthogonal to the guide grooves 8, 8. The projections 25, 25 integrally formed with projection members 24, 24 (hereinafter explained in detail) are sidably fitted to the hollows 9. In case the paper-holding ruler 60 is placed and fixed out of the installation table 3, the projections 25, 25 are engaged with concavities 62, 62 of the foot portions 61, 61. A back surface of the base 2 has a pair of bottom face grooves 10, 10 in position where corresponding to the guide grooves 8, 8. By fixing the foot portions 61, 61 of the paper-holding ruler 60 in the bottom face grooves 10, 10, the paper-holding ruler 60 can be positioned and fixed at a given place.

The positioning means 12, as shown in FIG. 9, comprises: the pair of projection members 24, 24 arranged in a pair of projection guiding-portions 13, 13 formed orthogonally to a pair of the bottom face grooves 10, 10; springs 23, 23 energizing the projection members 24, 24 to the bottom face grooves 10, 10; a projection operation member 17 keeping the projections 25, 25 engaged with the concavities 62, 62 of the foot portions 61, 61; and a pair of intermediate operation members 21, 21 placed between the projection operation member 17 and the springs 23, 23.

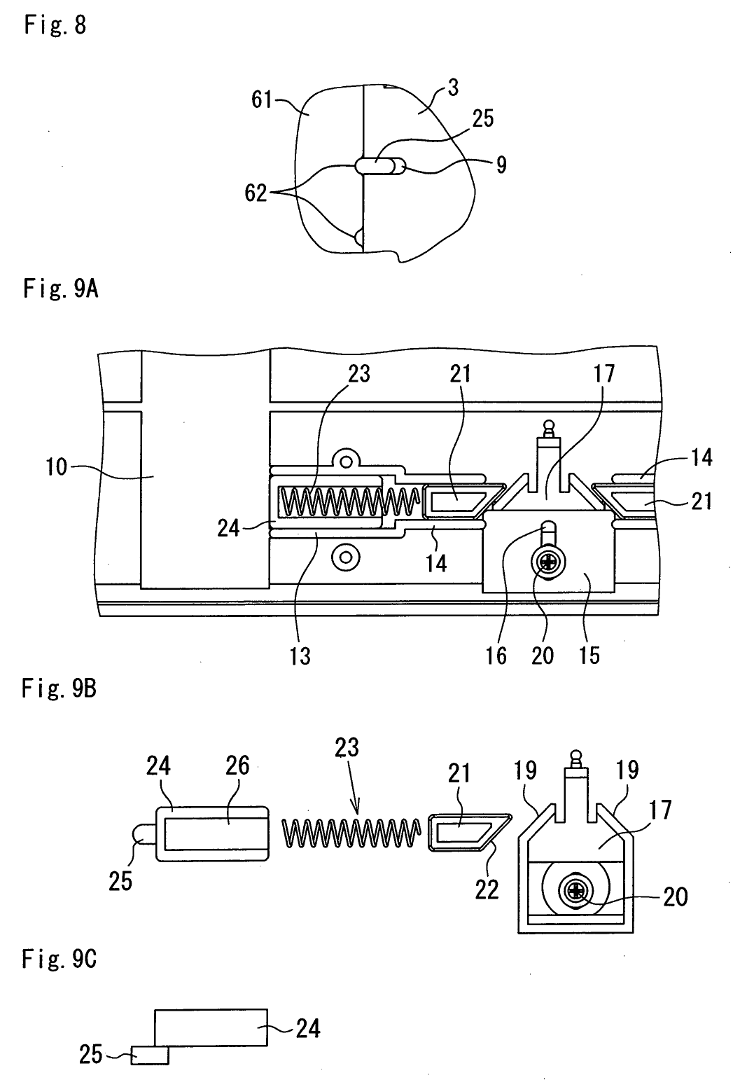

Referring to FIG. 9, the pair of projection guiding-portions 13, 13 and intermediate operation guides 14, 14 are integrally provided at the backside of the base 2 and also placed between the pair of bottom face grooves 10, 10. At the connection between the projection guiding-portions 13, 13 and bottom face grooves 10, 10, the hollows 9, 9 (see FIG. 8) are formed running through the top face of the projection guiding-portions 13, 13 and the installation table 3. Between the bottom face grooves 10, 10, a retaining portion 15 movably holding the projection operation member 17 is integrally provided on the back face of the base 2. Here, the retaining portion 15 is provided having a step that the projection operation member 17 can be placed between the retaining portion 15 and the installation table 3. See FIG. 4.

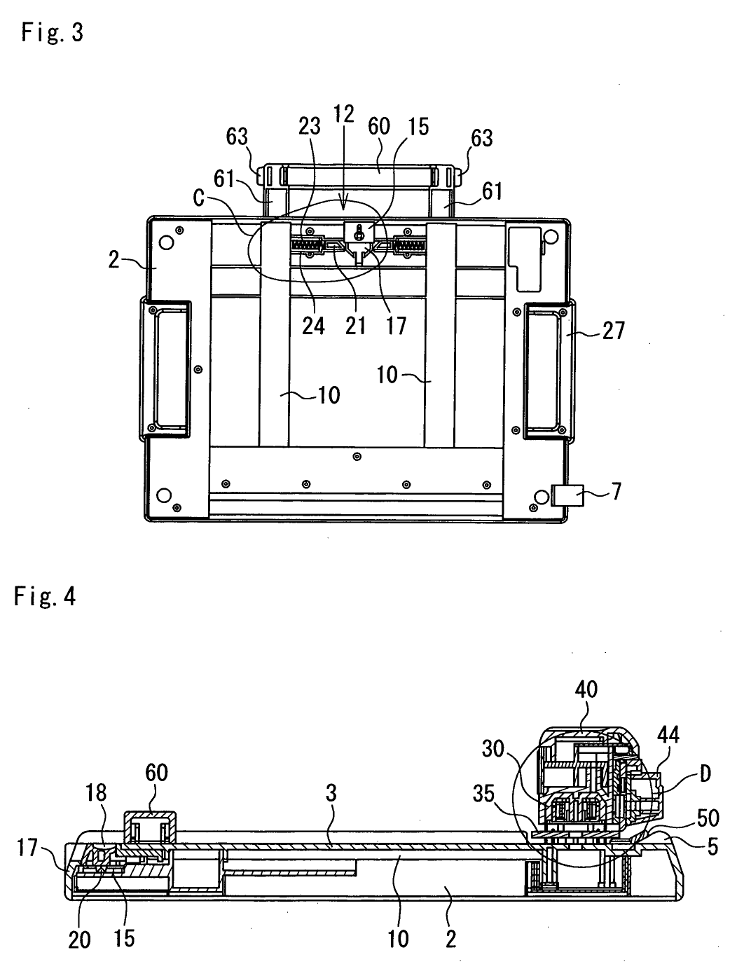

The projection operation member 17 as shown in FIGS. 3 and 9 has a pair of pressing portions 19, 19 with inclination of approximately 45 degrees to a direction that the projection operation member 17 is moved. The retaining portion 15 has a threaded hole (not shown) that a screw 20 is mounted. The surface of the projection operation member 17 has an operation surface 18 (see FIGS. 2 and 4), and the projection operation member 17 is installed into the retaining portion 15 making the operation surface 18 approximately being on a level with the installation table 3. Through the mounting screw 20, the projection operation member 17 can be movably retained along a guiding long-hole 16 formed on the retaining portion 15. The projection members 24, 24 are further integrally provided with the projections 25, 25 at one end thereof and have spring holders 26, 26 inside thereof. Here, one ends of the intermediate operation members 21, 21 are made contact with the springs 23, 23, whereas the other ends thereof have pressed surfaces 22, 22 with inclination of 45 degrees.

The positioning means 12 of the first embodiment is installed in the base 2 in the following steps. The projection operation member 17 is first fitted into the retaining portion 15 provided on the back of the base 2 in such a manner that the pressing portions 19, 19 are faced toward the guide rail 30. The mounting screw 20 is introduced into the guiding long-hole 16 and then installed in the threaded hole of the projection operation member 17. The projection members 24, 24 are placed inside of the projection guiding-portions 13, 13 so as to have the projections 25, 25 fitted into the hollows 9, 9. The intermediate operation members 21, 21 are then introduced into the intermediate operation guides 14, 14. The springs 23, 23 are next compressed and installed into the spring holders 26, 26 of the projection members 24, 24 and the intermediate operation guides 14, 14. The pressing portions 19, 19 of the projection operation member 17 are abutted in this condition to the pressed surfaces 22, 22 of the intermediate operation members 21, 21. While heading toward the guide grooves 8, 8, the projections 25, 25 are engaged with the concavities 62, 62 formed on the foot portions 61, 61 of the paper-holding ruler 60. After the positioning means 12 is installed on the back of the base 2, the positioning means 12 may optionally be covered to avoid external exposure.

In the first embodiment, when the paper-holding ruler 60 needs to be fixed, the projection operation member 17 is first moved toward the side of the guide rail 30 to give more energy toward the springs 23, 23. The projections 25, 25 projected toward the guide grooves 8, 8 with the springs 23, 23 are engaged with the concavities 62, 62 formed on the foot portions 61, 61 to be fixed. On the other hand, when changing the position of the paper-holding ruler 60, the projection operation member 17 is simply moved away from the guide rail 30 lessening the energy toward the springs 23, 23. The foot portions 61, 61 become movable along the guide grooves 8, 8. Based on the structure above, time taken for cutting the sheet materials can be notably shortened.

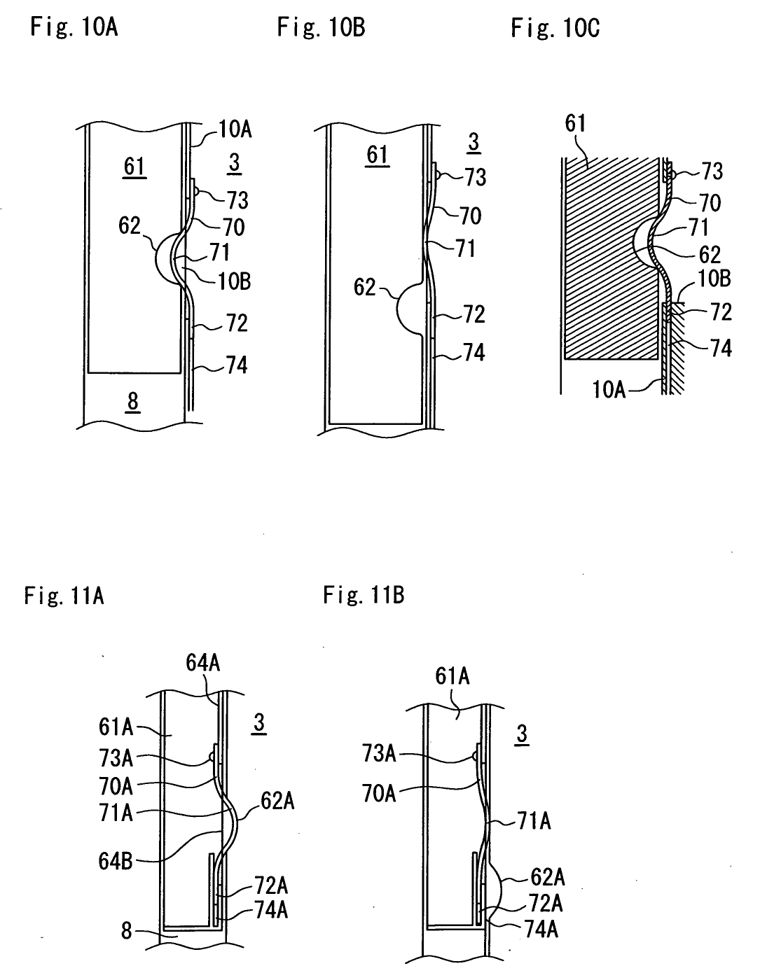

Next, the positioning means of another embodiments are still explained hereinafter, mainly focusing on structures of foot portions and projections. In the second embodiment of the positioning means, as shown in FIG. 10, one end portions of plate springs 70, 70 are fastened with screws 73, 73 to sides 10A, 10A of the bottom face grooves 10, 10 formed on the back of the installation table 3. The plate springs 70, 70 have curvatures 71, 71 curved toward the guide grooves 8, 8. The curvatures 71, 71 project toward the guide grooves 8, 8 through openings 10B, 10B to engage with concavities 62, 62 on the foot portions 61, 61. The other ends of the plate springs 70, 70, plate spring end portions 72, 72, are movably retained to stowing portions 74, 74 formed on the sides 10A, 10A of the bottom face grooves 10, 10.

For positioning and fixing the paper-holding ruler 60 in the second embodiment, the steps needed to be taken are: 1] transferring the foot portions 61, 61 along the guide grooves 8, 8 from the state where the curvatures 71, 71 are placed out of the concavities 62, 62 as shown in FIG. 10B to the state where the curvatures 71, 71 are placed facing with the concavities 62, 62 as shown in FIGS. 10A and 10C; 2) having the curvatures 71, 71 being projected toward the concavities 62, 62 with elastic force; and 3) having the curvatures 71, 71 engaged with the concavities 62, 62. According to the second embodiment explained above, because the projections are replaced by the curvatures of the plate springs, it succeeds to fabricate the positioning means with lesser pieces compared with the first embodiment. Time needed for cutting the sheet materials is further shortened.

In the third embodiment of the positioning means, as shown in FIG. 11, one ends of plate springs 70A, 70A are fastened with a screw 73A on the back of foot portions 61A, 61A, for example, on sides 64A, 64A of the foot portions 61A, 61A. The plate springs 70A, 70A have curvatures 71A, 71A curved toward the installation table 3. The curvatures 71A, 71A project toward openings 64B, 64B so as to engage concavities 62A, 62A on the installation table 3. The other ends of the plate springs 70A, 70A, plate spring end portions 72A, 72A, are movably retained to stowing portions 74A, 74A formed on the sides 64A, 64A of the foot portions 61A, 61A.

For positioning and fixing the paper-holding ruler 60 in the third embodiment, the steps needed to be taken are: 1) transferring the foot portions 61A, 61A along the guide grooves 8, 8 from the state where the curvatures 71A, 71A are placed out of the concavities 62A, 62A as shown in FIG. 11B to the state where the curvatures 71A, 71A are placed facing with the concavities 62A, 62A as shown in FIG. 11A; 2) having the curvatures 71A, 71A being projected toward the concavities 62A, 62A with elastic force; and 3) having the curvatures 71A, 71A engaged with the concavities 62A, 62A. According to the third embodiment explained above, the same effect with the second embodiment can be attained.

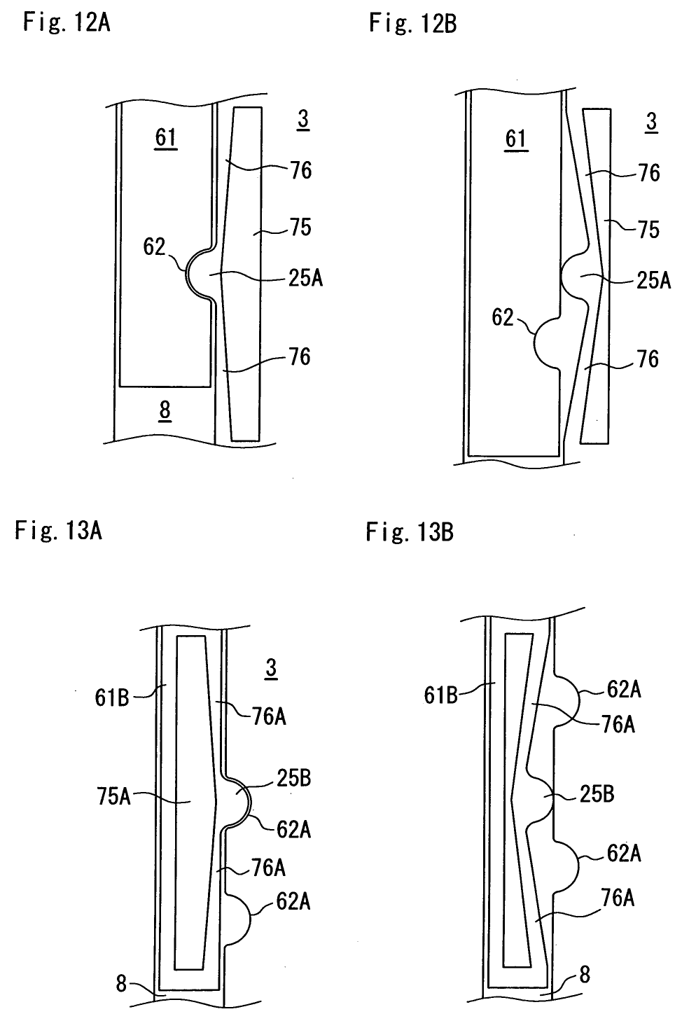

In the fourth embodiment of the positioning means, as shown in FIG. 12, cut-out portions 75, 75 are provided by cutting out the back of the installation table 3, specifically, the installation table 3 proximal to the bottom face grooves 10, 10. The cut-out portions 75, 75 where facing toward the guide grooves 8, 8 have swellings 25A, 25A at the center thereof and deflection areas 76, 76 integrally formed therewith at both sides of the swellings 25A, 25A. The swellings 25A, 25A are thus engaged with concavities 62, 62 formed on the foot portions 61, 61.

For positioning and fixing the paper-holding ruler 60 in the fourth embodiment, the steps needed to be taken are: 1) transferring the foot portions 61, 61 along the guide grooves 8, 8 from the state where the swellings 25A, 25A are placed out of the concavities 62, 62 as shown in FIG. 12B to the state where the swellings 25A, 25A are placed facing with the concavities 62, 62 as shown in FIG. 12A; 2) having the swellings 25A, 25A being projected toward the concavities 62, 62 with elastic force of the deflection areas 76, 76; and 3) having the swellings 25A, 25A engaged with the concavities 62, 62. According to the forth embodiment explained above, further reduction of the parts can be attained compared to the second and third embodiments.

In the fifth embodiment of the positioning means, as shown in FIG. 13, cut-out portions 75A, 75A are provided by cutting out the foot portions 61B, 61B. The surfaces of the cut-out portions 75A, 75A facing toward the installation table 3 have swellings 25B, 25B at the center thereof and deflection areas 76A, 76A integrally formed therewith at both sides of the swellings 25B, 25B. The swellings 25B, 25B are thus engaged with concavities 62A, 62A formed on the installation table 3.

For positioning and fixing the paper-holding ruler 60 in the fifth embodiment, the steps needed to be taken are: 1) transferring the foot portions 61B, 61B along the guide grooves 8, 8 from the state where the swellings 25B, 25B are placed out of the concavities 62A, 62A as shown in FIG. 13B to the state where the swellings 25B, 25B are placed facing with the concavities 62A, 62A as shown in FIG. 13A; 2) having the swellings 25B, 25B being projected toward the concavities 62A, 62A with elastic force of the deflection areas 76A, 76A; and 3) having the swellings 25B, 25B engaged with the concavities 62A, 62A. According to the fifth embodiment explained above, the same effect with the fourth embodiment can be attained.

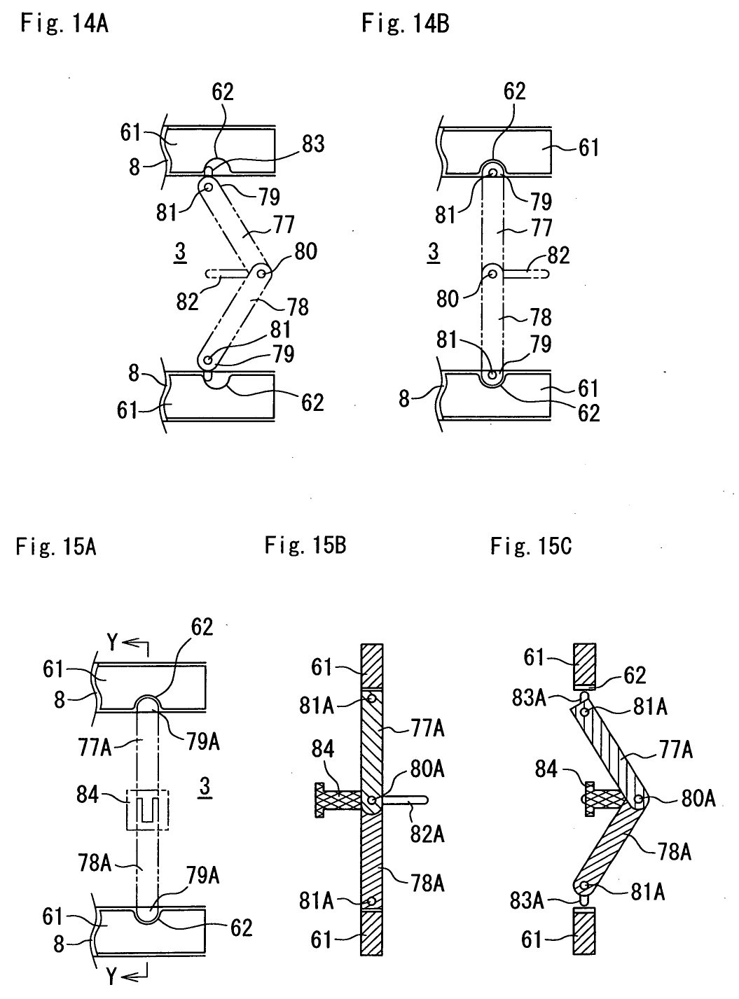

In the sixth embodiment of the positioning means, as shown in FIG. 14, on the back of the installation table 3, a first hole 82 and second holes 83, 83 are provided approximately orthogonal to each other. The first hole 82 is made in the same direction that the foot portion 61 is moved while the second holes 83, 83 are made intersecting with the guide grooves 8, 8. At the first hole 82, a first link 77 and a second link 78 are movably fitted on a pivotable connection 80. At the second holes 83, 83, axial parts 81, 81 provided on each end 79, 79 of the first link 77 and the second link 78 are movably fitted. Each of the ends 79, 79, as shown in FIG. 14B, is projected into the guide grooves 8, 8 so as to engage with the concavities 62, 62 of the foot portions 61, 61. The pivotable connection 80 further has an operation member (not shown in figures) operating the first link 77 and the second link 78.

For positioning and fixing the paper-holding ruler 60 in the sixth embodiment, the steps needed to be taken are: 1) transferring the foot portions 61, 61 along the guide grooves 8, 8 from the state where each of the ends 79, 79 of the first link 77 and the second link 78 is placed out of the concavities 62, 62 of the foot portions 61, 61 as shown in FIG. 14A to the state where each of the ends 79, 79 is placed facing with the concavities 62, 62 as shown in FIG. 14B; 2) moving the operation member attached to the one end of the pivotable connection 80 along the second hole 82; 3) having each of the ends 79, 79 being projected toward the sides of the guide grooves 8, 8; and 4) having the ends 79, 79 engaged with the concavities 62, 62. According to the sixth embodiment explained above, because no member such as projections or swellings, which is needed to be energized by elastic force, is provided unlike the aforementioned other embodiments, it enables to have the foot portions of the paper-holding means more firmly fixed thus giving more stable cutting operations.

In the seventh embodiment of the positioning means, as shown in FIG. 15, on the back of the installation table 3, a first hole 82A is provided perpendicular to the installation table 3 while a second holes 83A, 83A are provided parallel to the installation table 3. The second holes 83A, 83A are then formed in the intersectional direction to which the foot portion 61 is moved. The first hole 82A is provided at the appropriate area on the back of the installation table 3. At the first long-hole 82A, a first link 77A and a second link 78A are movably fitted on a pivotable connection 80A. At the second holes 83A, 83A, axial parts 81A, 81A provided on each end 79A, 79A of the first link 77A and the second link 78A are movably fitted. Each of the ends 79A, 79A, as shown in FIG. 15A, is projected into the guide grooves 8, 8 so as to engage with the concavities 62, 62 of the foot portions 61, 61. The pivotable connection 80A further has an operation member 84 operating the first link 77A and the second link 78A.

For positioning and fixing the paper-holding ruler 60 in the seventh embodiment, the steps needed to be taken are: 1) transferring the foot portions 61, 61 along the guide grooves 8, 8 from the state where each of the ends 79A, 79A of the first link 77A and the second link 78A is placed out of the concavities 62, 62 of the foot portions 61, 61 as shown in FIG. 15C to the state where each of the ends 79A, 79A is placed facing with the concavities 62, 62 as shown in FIG. 15B; 2) having the pivotal connection 80A moved along the second hole 82A with the operation member 84; 3) having each of the ends 79A, 79A being projected toward the sides of the guide grooves 8, 8; and 4) having the ends 79A, 79A engaged with the concavities 62, 62. According to the seventh embodiment explained above, the same effect with the sixth embodiment can be attained.

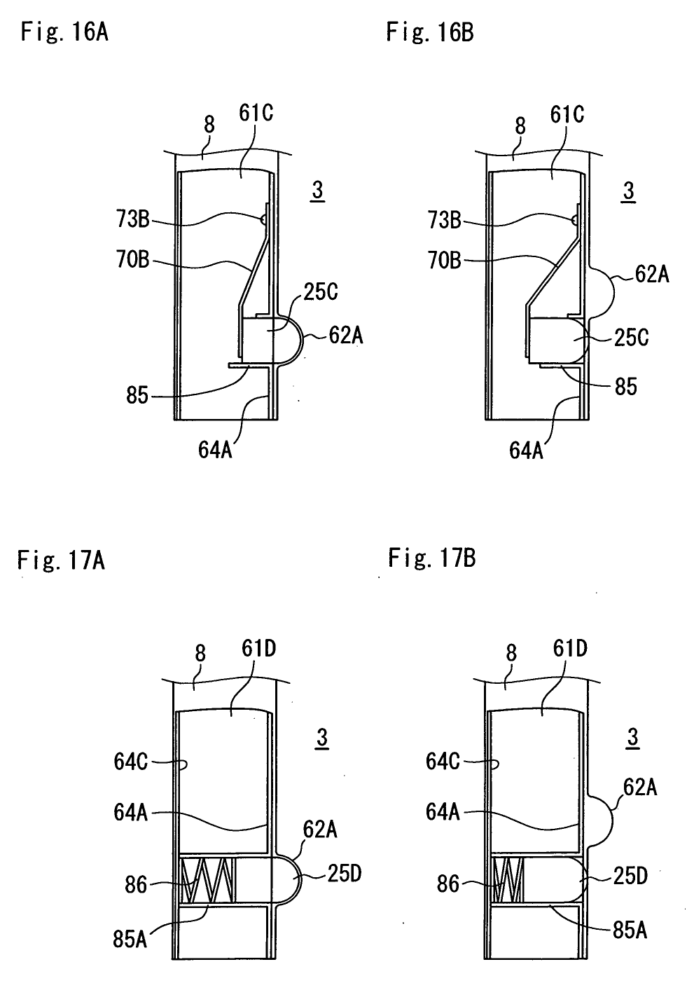

In the eighth embodiment of the positioning means, as shown in FIG. 16, on the back of foot portions 61C, 61C such as sides 64A, 64A, one ends of plate springs 70B, 70B are fastened through screws 73B, 73B. The other ends thereof have projections 25C, 25C projected toward the side of the installation table 3. The projections 25C, 25C are projected from guiding member 85, 85 integrally formed on the sides 64A, 64a of the foot portions 61C, 61C so as to engage with concavities 62A, 62A formed on the installation table 3.

For positioning and fixing the paper-holding ruler 60 in the eighth embodiment, the steps needed to be taken are: 1) transferring the foot portions 61C, 61C along the guide grooves 8, 8 from the state where the projections 25C, 25C are placed out of the concavities 62A, 62A as shown in FIG. 16B to the state where the projections 25C, 25C are placed facing with the concavities 62A, 62A as shown in FIG. 16A; 2) having the projections 25C, 25C being projected toward the concavities 62A, 62A with elastic force of the plate springs 70B, 70B; and 3) having the projections 25C, 25C engaged with the concavities 62A, 62A. According to the eighth embodiment explained above, time needed for the cutting operation can be shortened as same as another embodiments.

In the ninth embodiment of the positioning means, as shown in FIG. 17, guiding members 85A, 85A integrally formed on the back of foot portions 61D, 61D are extended from sides 64A, 64A facing the installation table 3 to the other sides 64C, 64C. The guiding members 85A, 85A hold coil springs 86, 86 and projections 25D, 25D therein, so that the projections 25D, 25D are energized toward the side of the installation table 3 with the coil springs 86, 86. The projections 25D, 25D are thus made projected from the guiding members 85A, 85A so as to engage with concavities 62A, 62A formed on the installation table 3.

For positioning and fixing the paper-holding ruler 60 in the ninth embodiment, the steps needed to be taken are: 1) transferring the foot portions 61D, 61D along the guide grooves 8, 8 from the state where the projections 25D, 25D are placed out of the concavities 62A, 62A formed on the installation table 3 as shown in FIG. 17B to the state where the projections 25D, 25D are placed facing with the concavities 62A, 62A as shown in FIG. 17A; 2) having the projections 25D, 25D being projected toward the concavities 62A, 62A with elastic force of the coil springs 86, 86; and 3) having the projections 25D, 25D engaged with the concavities 62A, 62A. According to the ninth embodiment explained above, the same effect with the eighth embodiment can be achieved.

Although the plate springs 70B, 70B and the coil springs 86, 86 are explained in the eighth and ninth embodiments respectively, these energized means are not limited thereto but may be any materials or constitutions as long as they have elastic characteristics.

1. A sheet cutter comprising: a base; a guide rail provided on the base; and a slider provided with a cutter and movably installed on the guide rail, wherein each of the slider and the guide rail has either a convex portion or a concave portion up and down in such a manner as to have the slider and the guide rail fitted each other.

2. A sheet cutter according to claim 1, wherein two contacts are additionally provided from side to side between the slider and the guide rail in such a manner that these two contacts are made detached from each other in cutting processes.

3. A sheet cutter comprising: a base; a guide rail provided on the base; a slider provided with a cutter and movably installed on the guide rail; and a cutter mat placed on a top surface of the base and installed in a fitting groove formed along the guide rail, wherein a guide portion is provided near the fitting groove so as to guide the cutter mat toward the fitting groove.

4. A sheet cutter according to claim 3, wherein a rotary end-holder is provided at at least one end of the fitting groove so as to hold the cutter mat in the fitting groove.

5. A sheet cutter according to claim 3, wherein an end fastener is provided at one end of the fitting groove to fasten one end of the cutter mat, and the rotary end holder is concurrently provided at the other end of the fitting groove to retain the other end of the cutter mat.

6. A sheet cutter comprising: a base; a guide rail provided on the base; a slider provided with a cutter and movably installed on the guide rail; a guide groove formed on a top surface of the base and provided orthogonal to the guide rail; and a paper-holding ruler positionally adjustable in the guide groove, wherein the paper-holding ruler is integrally and orthogonally provided with a foot portion so as to be slidable along the guide groove, and a positioning means is also provided between foot portions or guide grooves so as to optionally position the paper-holding ruler.

7. A sheet cutter according to claim 6, wherein the positioning means comprises: concavities formed on either the foot portion or the base; protrusion engaged with the concavities; and a protrusion operation member keeping the protrusion engaged.

8. A sheet cutter according to claim 6, wherein the guide groove has a bottom closing width wider than a top opening width so as to hold the foot portion thereinto.

9. A sheet cutter according to claim 6, wherein the positioning means comprises: concavities provided on either the foot portion or a top surface of the base; a plate spring; and protrusion integrally formed with the plate spring to be energized toward the concavities.

10. A sheet cutter according to claim 6, wherein the positioning means comprises: concavities provided on either the foot portion or a top surface of the base; and a protrusion integrally formed on either the foot portion or the top surface of the base to be energized toward the concavity.

11. A sheet cutter according to claim 6, wherein the positioning means comprises: concavities provided on the foot portion; and a protrusion provided on the base and movable toward the concavities through a linkage with an operation member.

12. A sheet cutter according to claim 6, wherein the positioning means comprises: concavities formed on a top surface of the base, and a protrusion energized toward the concavities by means of an energizing means.

13. A sheet cutter according to of claim 1, wherein the sheet cutter may have a handle.
